(19) United States
(12) Patent Application Publication
(10) Pub. No.: US 2003/0022961 A1
(43) Pub. Date: Jan. 30, 2003

(54) Friction material and method of mix-fibrillating fibers

(76) Inventors: Satoshi Kusaka, Saitama (JP); Yosuke Sasaki, Saitama (JP)

Correspondence Address: Finnegan, Henderson, Farabow,, Garrett & Dunner, L.L.P., 1300 I Street, N.W., Washington, DC, 20005-3315, US

(21) Appl. No.: 10/101,742

(22) Filed: Mar. 21, 2002

(30) Foreign Application Priority Data
Mar. 23, 2001 (JP) 2001-085297
Mar. 23, 2001 (JP) 2001-085299

(51) Int. Cl. C08J 5/14

(52) U.S. Cl. 523/152; 523/155

(57) ABSTRACT

A friction material comprising a fibrous reinforcement, a friction modifier and a binder, characterized by being free from asbestos fiber and containing, as the organic fibrous reinforcement, a mixture of a dry aramid pulp with at least one member selected from the group consisting of a wet aramid pulp, a woodpulp and an acrylic pulp.

### BACKGROUND OF THE INVENTION

1. Field of the Invention

This invention relates to friction materials. In particular, it relates to friction materials to be used in industrial machines, railway vehicles, luggage buns, passenger cars and the like. More specifically, it relates to brake pads, brake linings, clutch facings, etc. to be employed for the above-described purposes.

This invention also relates to a method of fibrillating a mixture of plural types of organic fibers. In particular, it relates to a method of mix-fibrillating organic fibers for improving material characteristics (retention of fillers, dispersion, reinforcing effect, etc.) as fibrous reinforcements for friction materials for brakes such as disc brakes and drum brakes of automobiles, motorcycles, railway vehicles and industrial machines, friction materials for clutches and fibrous reinforcements for various molded articles such as molded resin articles, molded rubber articles and molded concrete articles.

2.Description of the Related Art

Friction materials to be used in brakes such as disc brakes and drum brakes and clutches are made up of friction modifiers imparting a frictional effect and controlling the friction performance, fibrous reinforcements exerting a reinforcing effect, binders integrating these materials to impart strength, etc. Among these components, fibrous reinforcements involve, for example, metal fibers, inorganic fibers and organic fibers. Since these fibers have their individual characteristics and all requirements cannot be fulfilled by using any single fiber, use has been usually made of mixtures of two or more thereof.

For the convenience in illustration, fibrous reinforcements of friction materials for brakes will be now illustrated as a typical example of the various fibrous reinforcements as cited above.

It has been a practice to produce friction materials by blending various materials including fibrous reinforcements, friction modifiers and binders, preforming the mixture thus obtained in a conventional manner and then heat-molding the same.

In friction materials mainly used in brakes, fibrous reinforcements are employed as one of the raw materials for elevating the strength. As substitutes for asbestos fibers, there have been employed fibrous reinforcements such as glass fibers, metal fibers such as copper fibers and steel fibers, organic fibers such as aramid fibers and acrylic fibers, and inorganic fibers such as potassium titanate fibers and Al₂O₃—SiO₂-based ceramic fibers. Since these fibers have their individual characteristics, it has been a practice to use mixtures of several types thereof. For example, there have been known friction materials containing organic fibers, inorganic fibers, metal fibers, fillers and binders (Japanese Patent Laid-open Hei 4-234479). Also, there have been known various organic fiber materials. Among these fibers, organic fibers, which are characterized by, for example, easily binding to binders, contribute to the improvement in the wear resistance in a temperature zone of not higher than 200° C. Aramid fibers may be cited as the most typical example of the organic fibers.

Typical examples of marketed aramid fibers include Kevlar (duPont), Twaron (Twaron Products) and Technola (Teilin, Ltd.).

In general, aramid fibers having been fibrillated (i.e., processed into pulp) are used in friction materials for brakes today. In the step of fibrillation, use is made of the wet method wherein aramid fiber cut into short pieces is dispersed in water at a low concentration and then passed between two rotary mill discs. However, this method suffers from some problems such as consuming a large amount of water, requiring much energy in dehydrating, drying and refining the treated pulp, and thus achieving a poor efficiency. In spite of the poor efficiency, this wet method has been employed. This is because aramid fibers would be burned and carbonized in the dry method (for example, Kevlar 29 manufactured by du Pont has heat resistance of 250 to 260° C.). Thus, there is no choice but to prepare aramid pulp by fibrillating aramid fiber by the wet method.

The defect of the conventional dry method resides in that in a conventional high-speed rotational impact mill in which fibers are cut by exposing to an impact or a shear due to pins or rotors having a specific structure rotating in a milling chamber, the milled pulpy material is retained over a long time and thus burned.

To overcome this problem, the present inventors invented a method of fibrillating aramid fiber characterized by dry-milling the aramid fiber in a mill having the main unit consisting of a milling chamber which has a raw material supply port located in the upper part, a rotary cutter rotating at a high-speed at the center and an inner wall made of a screen surrounding the above-described rotary cutter and is provided with a fixed cutter symmetrically located on the upper inclined face connected to the above-described screen, and an emission chamber located in the outer periphery of the above-described screen of the above-described milling chamber to thereby obtain a pulpy material

By using this method, the milled pulpy material is quickly discharged from the mill within a short period of time without carbonization,In a friction material containing a dry aramid pulp (i.e., an aramid pulp obtained by the dry fibrillation method) proposed formerly, the average fiber length of the pulp at the fibrillation is determined depending on the screen size. With a decrease in the screen size, the average fiber length of the obtained pulp is shortened. Although such a pulp shows favorable material characteristics in a production process wherein the stirred materials are directly poured into a heat mold and level-weighed, it suffers from a problem of worsening of the preforming properties in the conventional preforming method. Moreover, the dry aramid pulp suffers from an additional problem that, because of the little fluffiness of the pulp, it is inferior in material retention properties to a conventional wet aramid pulp (i.e., an aramid pulp obtained by the wet fibrillation method) in some cases (for example, a mixture containing a large amount of large particles) and thus causes segregation of the material after stirring.

Also, under that present economical situation, it is severely required to lower costs in the fields of the automobile industry, the railway vehicle industry, the industrial machine industry, the industries of manufacturing molded articles (resins, concretes, rubbers, etc.) and the like.

Accordingly, it is not accepted to use expensive fibers such as aramid fibers alone as fibrous reinforcements, though aramid fibers are excellent in performance. Namely, it is required to use aramid fibers together with other less expensive organic fibers.

In case of mixing plural types of pulps by the conventional mixing method (in particular, the dry mixing method), however, it is difficult to uniformly mix plural types of pulps.

### SUMMARY OF THE INVENTION

The present invention, which has been made to solve these problems occurring in the related art, aims at obtaining a friction material which has improved material retention properties and preforming properties of the dry aramid pulp while taking advantage of the low processing cost, and favorable dispersion and level-weighing characteristics of the dry aramid pulp.

To solve these problems encountering in the related art, the present invention aims at obtaining a uniformly mixed pulp in case of fibrillating a mixture of plural types of organic fibers.

To overcome the above-described problems, the present inventors conducted extensive studies to lower the cost of organic fibrous reinforcements and improve the material retention properties and preforming properties thereof,

As a result, they paid their attention to the fact that desirable material retention properties and preforming properties, which are disadvantages of the existing dry aramid pulp, are ensured by mixing the dry aramid pulp with pulps made of other materials, thus achieving the present invention.

Further to overcome the above-described problems, the present inventors conducted extensive studies on fibrillation of fibrous reinforcements at a low cost and improvement in the uniform mixing properties of plural types of organic fibers.

As a result, they paid attention to the fact that a uniformly mixed pulp can be obtained without mixing pulps (i.e., fibrillated fibers) by preparing several types of organic fibers at a desired ratio prior to the fibrillation, roughly pre-mixing these fibers and then fibrillating the mixture simultaneously in a single fibrillation apparatus, thereby achieving the present invention.

Accordingly, the above-described problems have been solved by the present invention by the following means.

(1) A friction material made up of a fibrous reinforcement, a friction modifier and a binder, characterized by being free from asbestos fiber and containing, as the organic fibrous reinforcement, a mixture of a dry aramid pulp with at least one member selected from the group consisting of a wet aramid pulp, a woodpulp and an acrylic pulp.

(2) The friction material as described in the above (1) characterized in that the above-described organic fibrous reinforcement contains from 1 to 99% by weight of the dry aramid pulp.

(3) A friction material as described in the above (1) or (2) characterized by containing 0.5% by weight or more of the above-described organic fibrous reinforcement.

(4) A method of mix-fibrillating fibers characterized by preliminarily mixing plural types of organic fibers at a definite ratio and then fibrillating the resultant mixture.

In the present invention, namely, a combination of a dry aramid pulp with at least one member selected from the group consisting of a wet aramid pulp a woodpulp and an acrylic pulp is used as a fibrous reinforcement so as to give a friction material which has a reinforcing effect and material retention properties and preforming properties while maintaining the merit of low cost.

As the above-described dry aramid pulp, use is made of a product obtained by using the dry fibrillation method wherein the material milled in a mill provided with a screen as described above is quickly discharged without burning.

As described above concerning the problems, a dry aramid pulp having a short average fiber length has a demerit of worsening of the preforming properties in the method with preforming. By combined with other pulp(s) as described above, the worsening of the preforming properties can be prevented. Thus, the dry aramid pulp can be used in an amount of from 1 to 99% by weight in the organic fibers.

### BRIEF DESCRIPTION OF THE DRAWINGS

FIG. 1 shows a vertical section of a mill to be used in fibrillating a short aramid fiber according to the present invention.

### DESCRIPTION OF THE PREFERRED EMBODIMENTS

In the mix-fibrillating method of the present invention, plural types of organic fibers are employed. Although it is preferable to use an aramid fiber as one of these fibers, it is mixed with other organic fibers having a high heat resistance and a high strength as far as possible so as to minimize the mixing ratio of the aramid fiber. Examples of other organic fibers include acryl, acrylic acid, cotton and linen. concerning the mixing ratio, from 10 to 99% of the aramid fiber may be mixed with from 1 to 90% of an acrylic fiber, still preferably from 10 to 80% of an acrylic fiber.

Now, a mode for the embodiment of the present invention will be described.

The friction material according to the present invention is a non-asbestos type friction material with the use of non-asbestos pulps as the fibrous reinforcements Namely, it contains as the main component an organic fibrous reinforcement made up of non-asbestos pulps, an inorganic fibrous reinforcement, a filler, an inorganic/organic friction modifier and a thermosetting resin binder.

Examples of the fibrous reinforcements as described above include organic fibers such as aramid fibers and flame-retardant acrylic fibers, metal fibers such as copper fiber and steel fiber, and inorganic fibers such as glass fibers, potassium titanate fibers and Al₂O₃—SiO₂-based ceramic fibers.

Examples of the inorganic filler include particles of metals such as copper, aluminum and zinc, scale-type inorganic materials such as vermiculite and mica, barium sulfate and

Examples of the binder include thermosetting resins such as phenolic resins (involving straight (100%) phenolic resin and various modified phenolic resins such as rubber-modified phenolic resins), melamine resins, epoxy resins and polyimide resins.

Examples of the friction modifier include powdery metals such as copper and zinc and organic friction modifiers such as synthetic rubbers and cashew nut resins. Examples of a lubricant include graphite and molybdenum disulfide. Examples of an abrasive include metal oxides such as alumina, silica, magnesia, zirconia and chromium oxide.

The friction material way have various compositions.

That is to say, one or more of friction materials may be used depending on the frictional characteristics (for example, coefficient of friction, wear resistance, vibration properties, squeal) required for the product.

A brake pad for disc brakes is produced as follows. First, a pressure plate is produced by forming into a definite shape by sheet metal pressing, degreasing, primer processing and applying an adhesive agent. Separately, powdery materials including fibrous reinforcements (heat-resistant organic fibers, metal fibers, etc.), an inorganic/organic filler, a friction modifier and a thermosetting resin binder are mixed together. After sufficiently homogenizing the mixed raw materials by stirring, the mixture is molded (preformed) at ordinary temperature under definite pressure. Next, the pressure plate and the preformed material thus obtained are heat-molded together at definite temperature under definite pressure in the heat-molding stop so as to rigidly integrate both fibers followed by after-curing and finishing. The steps are the same as those employed in the conventional methods.

The aramid pulp to be used in the friction material of the present invention is a pulp in which an aramid fiber has been fibrillated and which has a specific surface area determined by the BET method of preferably from 3 to 25 m²/g and a freeness measured by the Canadian Standard Method as defined in JIS P 3121 “Pulp Freeness rest Method” of preferably from 100 to 700 ml, still preferably from 150 to 700 ml.

Concerning the mixing ratio of the aramid pulp in the organic fibers, totally favorable results (i.e., the reinforcing effect, the material retention properties and the preforming properties) can be obtained by substituting from 1 to 99% by weight, preferably from about 50% by weight (namely, a content of 50% by weight), of the dry aramid pulp by other pulp(s).

The acrylic pulp can be obtained by using generally known acrylic fiber as the raw material and fibrillating them with a paper-making refiner such as a disc refiner. It is also possible to use a branched acrylic pulp in which a large number of fine hairy filaments are branched from straw-like acrylic fiber stems having a linear void almost parallel to the lengthwise direction of the fiber.

These acrylic fibers include acrylic polymers made up of, for example, 60% by weight or more of acrylonitrile with 40% by weight or less of an ethylenic monomer copolymerizable with acrylonitrile and mixtures of two or more of these acrylic polymers. Examples of the ethylenic monomer copolymerizable with acrylonitrile include acrylic acid, methacrylic acid and esters thereof (methyl acrylate, ethyl acrylate, methyl methacrylate, ethyl methacrylate, etc.), vinyl acotate, vinyl chloride, vinylidene chloride, acrylamide, methacrylamide, methacrylonitrile, allylsulfonic acid, methanesulfonic acid and styrenesulfonic acid.

The freeness, which is an indication showing the extent of refining of pulp in the paper manufacturing industry, of the acrylic pulp to be used in the present invention is not restricted but appropriately selected depending on the characteristics of the friction material. It is preferable to use an acrylic pulp having a freeness of from about 200 to 600 cc.

The average fiber length and the average fiber diameter of the cellulose fibers constituting the woodpulp to be used in the present invention are not restricted. It is preferable that the fiber length ranges from 1 to 10 mm, still preferably from 1.5 to 5.0 mm, while the average fiber diameter ranges from 10 to 100 μm, still preferably from 30 to 40 μm. It is particularly preferable to use a cellulose fiber having a high strength and excellent heat resistance. Such a cellulose fiber can be produced by, for example, the viscous method from pulp

It is recommended that the content of the organic fibrous reinforcement made up of the various pulps as described above amounts to 0.5 to 10% by weight of the whole friction material.

Now, the present invention will be described in greater detail by reference to the following examples. However, it is to be understood that the present invention is not construed as being restricted to these examples.

### Examples 1 to 9 and Comparative Examples 1 to 3

### Production of Friction Material Samples

Friction materials were produced by using the materials as listed in Table 2 as the organic fibrous reinforcements for producing friction materials, mixing the raw materials at the mixing ratio as specified in Table 1 and employing the same steps as those in the existing production process for brake pads. Table 2 summarizes the characteristics of the friction materials evaluated in accordance with the items and methods as specified in Table 3.

As the dry aramid pulp, use was made of three types of aramid pulps obtained by using Kevlar K29 (cut into 13 mm, du Pont) as the aramid fiber and fibrillating by using three types of screens (1.5, 2.0 and 3.0 mm in pore size) in a Mesh Mill IIA0-2542 25 (Horai).

As the conventional wet aramid pulp, use was made of Kevlar Pulp IF538 (du Pont).

In Examples 1 to 3, the dry aramid pulp obtained by using the screen having a pore size of 1.5 mm was combined with the irrespective other pulps. In Examples 4 to 6, the dry aramid pulp obtained by using the screen having a pore size of 2.0 mm was combined with the respective other pulps. In Examples 7 to 9, the dry aramid pulp obtained by using the screen having a pore size of 3.0 mm was combined with the respective other pulps. In comparative Examples 1 to 3, the dry aramid pulps of the above-described three types were each used alone.

TABLE 1
Mixing conditions

| Material | Wt. % |
|---|---|
| Binder | 10 |
| Filler | 28 |
| Organic friction modifier | 10 |
| Inorganic friction modifier | 28 |
| Inorganic fibrous reinforcement | 20 |
| Organic fibrous reinforcement | 4 |

TABLE 2
Relation between mode of using pulp and performance evaluation data

| | | | | | | | | | | | Comp. | | |
|---|---|---|---|---|---|---|---|---|---|---|---|---|---|
| | | Example | | | | | | | | | Example | | |
| | | 1 | 2 | 3 | 4 | 5 | 6 | 7 | 8 | 9 | 1 | 2 | 3 |
| Organic fibrous | Dry aramid pulp | 2 | 2 | 2 | 0 | 0 | 0 | 0 | 0 | 0 | 4 | 0 | 0 |
| reinforcement | (1.5 mm in diameter) | | | | | | | | | | | | |
| | Dry aramid pulp | 0 | 0 | 0 | 2 | 2 | 2 | 0 | 0 | 0 | 0 | 4 | 0 |
| | (2.0 mm in diameter) | | | | | | | | | | | | |
| | Dry aramid pulp | 0 | 0 | 0 | 0 | 0 | 0 | 2 | 2 | 2 | 0 | 0 | 4 |
| | (3.0 mm in diameter) | | | | | | | | | | | | |
| | Wet aramid pulp | 2 | 0 | 0 | 2 | 0 | 0 | 2 | 0 | 0 | 0 | 0 | 0 |
| | Woodpulp | 0 | 2 | 0 | 0 | 2 | 0 | 0 | 2 | 0 | 0 | 0 | 0 |
| | Acrylic pulp | 0 | 0 | 2 | 0 | 0 | 2 | 0 | 0 | 2 | 0 | 0 | 0 |
| Evaluation on data | Material retention | ◯ | ◯ | ◯ | ◯ | ◯ | ◯ | ◯ | ◯ | ◯ | Δ | Δ | Δ |
| | Preforming properties | ◯ | ◯ | ◯ | ◯ | ◯ | ◯ | ◯ | ◯ | ◯ | X | Δ | Δ |
| | properties | | | | | | | | | | | | |
| | Cracking after test | ◯ | ◯ | ◯ | ◯ | ◯ | ◯ | ◯ | ◯ | ◯ | ◯ | ◯ | ◯ |

TABLE 3
Criteria of evaluation

| Item | Evaluation method | O | Δ | x |
|---|---|---|---|---|
| Material retention | Sieve analysis: | <8 g | 8 to 15 g | >15 g |
| properties | passing through 1.7 mm-mesh (g/100 g) | | | |
| Performing | Disintegration by hand operation: | None | Not more than | More than 5% |
| properties | (ratio of disintegrating individuals) | | 5% | |
| Cracking after test | JASO General performance test: | None | Fine cracking | Cracking |
| | judged with naked eye | | | |

### Stirring Conditions

1.5 kg of each of the mixture as listed in Table 2 was stirred in a 10 liter Eirich mixer for 4 minutes.

### Molding Conditions

A brake pad was produced by preforming, heat-molding and heat-treating each as in the conventional method.

### Method of Evaluating Material Retention Properties

Raw materials were uniformly mixed by stirring at the ratio as specified in Table 2 The obtained composition was preformed into tablets and then dropped onto meshes (having larger and smaller pore Sizes) overlapped each other. Evaluation was made based on the weight of the material passing through the 1.7-mm mash (i.e., the smaller one). The materials retained by the pulp remained on the meshes together with the pulp, while unretained materials passed through the meshes.

As the results shown in Table 2 indicate, the material retention properties were improved by substituting a half of the dry aramid pulp by other pulps, similarly, the preforming properties were improved thereby. Moreover, no problem arose in the cracking resistance after the completion Of the general performance test.

Next, the aramid fiber to be used in the mix-fibrillating method of the present invention will be illustrated,

Aramid resins which are raw materials for preparing aramid (aromatic polyamide) pulps used as fibrous reinforcements are obtained from aromatic diamine and aromatic dicarboxylic acid components amounting to 85% by mol or more of amide bonds.

Specific examples thereof include poly-para-phenylene terephthalamide, poly-meta-phenylene terephthalamide, poly-para-benzamide, poly-4,4′-diaminobenzanilide, poly-para-phanylene-2,6-naphthalic amide, copoly-para-phenylene/4,4′- (3,3′-dimethylbiphenylene)-terepht halamide, copoly-para-phenylene/2,5-pyridylene-terephthalamide, poly-ortho-phenylene phthalanide, poly-meta-phenylene phthalamide, poly-para-phenylene phthalamide, poly-ortho-phenylene isophthalamide, poly-para-phenylene isophthalamide, poly-ortho-phenylene terephthalamide, poly-1,5-naphthalone phthalamide, poly-4,4′-diphenylene ortho-phthalamide, poly-4,4′-diphenylene isophthalamide, poly-1,4-naphthalene phthalamide, poly-1,4-naphthalene isophthalamide, poly-1,5-naphthalene isophthalamide and the like; aromatic polyamides containing alicyclic amines typified by compounds prepared by substituting a part of the benzene nuclei of these aromatic diamines by piperazine, 1,5-dimethylpiperazine or 2,5-diethylpiperazine; and aromatic polyamide copolymers containing two phenyl groups consisting of aromatic diamines bonded via an ether bond (for example, 3,3′-oxydiphenylenediamine, 3,4′-oxydiphenylenediamine) or groups such as —S—, —SO₂—, —CO—, —NH—, etc. (for example, poly-3,3′-oxydiphenylene terephthalamide/poly-para-phenylene terephthalamide copolymer, poly-3,4′-oxydiphenylene terephthalamide/poly-para-phenylene terephtalimide copolymer).

Among these compounds, poly-para-phenylene terephthalamide and polybenzamide, which are marketed each under the trade name Kevlar from du Pont, are favorable because of the outstandingly excellent tensile characteristics and heat resistance thereof.

The aramid pulp to be used in the mix-fibrillating method of the present invention is a pulp in which an aramid fiber has been fibrillated and which has a specific surface area determined by the BET method of preferably from 0.2 to 10 m²/g and a freeness measured by the Canadian Standard Method as defined in JIS P 8121 “Pulp Freeness Test Method” of preferably from 100 to 700 ml, still preferably from 150 to 700 ml.

As will be described hereinafter, the aramid pulp according to the mix-fibrillating method of the present invention can be easily dispersed uniformly in a mixture and have an excellent performance of maintaining powdery fillers in a favorable dispersion state therein. Achievement of a favorable dispersion of the aramid pulp and powdery fillers in a mixture indicates that the reinforcing effect of the aramid pulp is enhanced.

The fibers to be fibrillated may be arbitrary fibers appropriate for the purpose, so long as they are organic fibers. These fibers may be in any:form, for example, cut fibers, continuous filaments or mixed fibers.

The fibrillation may be performed either by the wet method or the dry method. Namely an appropriate method may be selected depending on the purpose of the fibrous reinforcement.

Next, an embodiment of the mix-fibrillating method of the present invention will be described by reference to the attached figure.

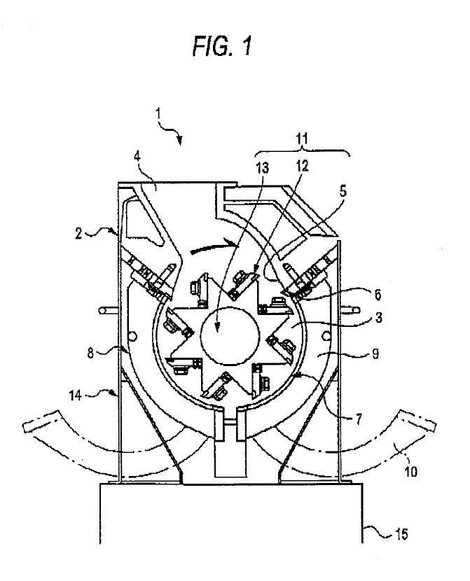

As FIG. 1 shows, a mill 1 of the cutting system to be used in fibrillating an aramid fiber according to the present invention has a structure wherein a rotary cutter 11 is provided in a milling chamber 3 of the main unit 2. On an upper inclined face 5 of the milling chamber 3 connected to a raw material supply port located in the upper part of the main unit 2, a fixed cutter 6 is symmetrically provided at such a location as enabling the achievement of synergistic milling effect by the fixed cutter 6 together with the rotary cutter.

In the rotary cutter 6, a large number of blades 12 are radially set to a rotor 13 so as to correspond to the fixed cutter 6. The inner wall of the milling chamber 3 is made of a screen 7. A circular emission chamber 9 surrounds the screen 7. The milled material having been milled in the milling chamber is introduced into this emission chamber via the screen 7. The screen 7 is set to the screen bearer 8. The emission chamber 9 is further connected to a suction air pathway 10 connected to a fan (not shown). By passing air through the screen 7 and the emission chamber 9, the passage of the milled material through the screen is accelerated and thus the milling material in the emission chamber 7 can be easily discharged from the main unit 2.

Owing to this construction, a structure allowing the establishment of a high heat radiation effect with little heat generation can be obtained.

A mixture of an short aramid fiber with an acrylic fiber, which is supplied from the raw material supply port 4 in the upper part of the mill 1, is milled zanily by the shear force applied between the rotary cutter 11 provided at the center of the milling chamber 3 and the fixed cutter S then the mixture is milled to give particles smaller than the pore size of the screen 7, it is discharged into the emission chamber 9 through the screen 7. In this step, the milled material collides with the screen 7 at a high speed due to the centrifugal force of the rotary cutter 11 applied on the milled material and the suction power of the air also acts on the milled material, which quickens the passage and discharge of the milled material.

Thus, there never arises the problem that the pulp of the mixture of the fibrillated aramid fiber/acrylic fiber is retained in the mill over a long time and burned.

Particles of the material larger than the pore size are once lifted up by the rotary cutter 11 and then milled repeatedly. Thus, the whole material can be finally discharged. In this step, the final particle size is determined depending on the pore size of the screen 7. Therefore, a desired particle size can be obtained by appropriately replacing the screen 7. Moreover, the suction power of the fan (not shown) connected also facilitates the quick discharge of the pulp of the aramid fiber/acrylic fiber mixture.

In FIG. 1, the reference numerals 14 and 15 respectively represent a door of the main unit and a mill stand.

Now, the mix-fibrillating method of the present invention will be described in greater detail by reference to the following examples. However, it is to be understood that the mix-fibrillating method of the present invention is not construed as being restricted to these examples.

### Example 1

### Wet Fibrillation

As a fibrillation apparatus, use was made of a Super Masscolloider MKZA10-15manufactured by Masuko Sangyo. An aramid fiber and an acrylic fiber cut into about 13 mm in length were put into water at a weight ratio of 1:1 and nixed well. Then the mixture was supplied into the apparatus together with water to give a pulp. The obtained pulp was dehydrated and dried. When the pulp was observed under a fluorescent microscope, it was found out that the aramid fiber was uniformly distributed.

### Example 3

### Dry Fibrillation

As a fibrillation apparatus, use was made of a Mesh Mill HA8-2542-25 manufactured by Horai. An aramid fiber and an acrylic fiber cut into about 13 mm in length were supplied via the raw material supply port at a weight ratio of 1:1 and mixed- well. When the obtained pulp was observed under a fluorescent microscopes it was found out that the aramid fiber was uniformly distributed.

According to the present invention, it becomes possible to use a dry aramid pulp, which can be produced at a low cost without worsening the material retention properties and preforming properties and yet maintaining the merit of low production cost, by mixing a dry aramid pulp (i.e., an aeramid pulp produced by the dry method) with a wet aramid pulp (i.e., an aramid pulp produced by the conventional wet method) or pulps made from other materials (woodpulp, acrylic pulp, etc.) Furthermore, the aramid pulp produced by the dry method suffers from no branching in the fiber stem and have a large fiber diameter, which contributes to the enhancement of the reinforcing effect even though a small content compared with the conventional pulps. Thus, the combined use of the aramid pulps obtained by the dry and wet methods ensures the achievement of favorable reinforcing effect, material retention properties and preforming properties.

Further, according to the mix-fibrillating method of the present invention, several types of fibers are prepared at a necessary ratio prior to fibrillation and then these fibers are fibrillated at the same time in a single fibrillation apparatus. Thus, the fibers of different types are uniformly mixed in the course of the fibrillation, either by the wet method or the dry method, to thereby give a pulp in which the fibers are uniformly mixed at a definite ratio. In, for example, dry agitation of a friction material, attention may be merely paid to the mixing and dispersion of powdery materials without worrying about the mixing of pulps with each other. Thus a uniformly agitated material can be easily obtained.

By simultaneously fibrillating plural types or fibers, which have been pre-mixed at an necessary ratio, in the step of fibrillating the fibers, furthermore, a pulp in a well-mixed state can be obtained without mixing again.

What is claimed is:

1. A friction material comprising a fibrous reinforcement, a friction modifier and a binder, characterized by being free from asbestos fiber and containing, as the organic fibrous reinforcement, a mixture of a dry aramid pulp with at least one member selected from the group consisting of a wet aramid pulp, a woodpulp and an acrylic pulp.

2. The friction material according to claim 1 characterized in that said organic fibrous reinforcement contains from 1 to 99% by weight of the dry aramid pulp.

3. A friction material according to claim 1 characterized by containing 0.5% by weight or more of said organic fibrous reinforcement.

4. A friction material according to claim 2 characterized by containing 0.5% by weight or more of said organic fibrous reinforcement.

5. A method of mix-fibrillating fibers which comprises steps of mixing plural types of organic fibers at a definite ratio, and fibrillating a mixture which is obtained in said step of mixing plural types of organic fibers.

6. A method of mix-fibrillating fibers according to claim 5, characterized by said step of mixing plural types of organic fibers at a definite ratio is carried out preliminarily.
